(19) United States
(12) Patent Application Publication
(10) Pub. No.: US 2025/0165871 A1
(43) Pub. Date: May 22, 2025

(54) MACHINE-LEARNING ENHANCED PRODUCTION PROCESS WITH MULTI-TARGET MODELLING

(71) Applicant: Merck Patent GmbH, Darmstadt (DE)

(72) Inventors: Rolf Roth, Griesheim (DE); Maximilian Schoen, Frankfurt (DE); Nitika Thakral, Los Angeles, CA (US); Gang Han-Adebekun, Cambridge, MA (US)

(21) Appl. No.: 19/033,895

(22) Filed: Jan. 22, 2025

Related U.S. Application Data
(63) Continuation of application No. PCT/EP2023/070089, filed on Jul. 20, 2023.
(60) Provisional application No. 63/369,137, filed on Jul. 22, 2022.

(51) Int. Cl. G06N 20/00

(52) U.S. Cl. CPC G06N 20/00

(57) ABSTRACT

A method and a system for improving a production process of a product via a computer wherein the computer runs a software performing a machine learning model which is used to predict target production process parameters based on specific input data of the production process and therefore trained with a specific training dataset regarding that input data and target parameters, and finally the predicted target parameters are used to improve the production process, wherein the machine learning model predicts at least two different target parameters at the same time and is therefore trained with a joint training data set adapted to the at least two target parameters.

### CROSS-REFERENCE TO RELATED APPLICATION

This application is a Continuation under 35 USC § 111(a) of International Patent Application No. PCT/EP2023/070089, filed Jul. 20, 2023, which claims priority to the U.S. Provisional Application No. 63/369,137, filed Jul. 22, 2022. The entire contents of these applications are incorporated herein by reference in their entirety.

The hereby described invention discloses a method for improving a production process by using a multi-target model.

### TECHNICAL FIELD

The invention deals with the technological area of machine learning supported bio-/chemical production processes.

### BACKGROUND OF THE INVENTION

When using machine learning algorithms there is typically one target parameter to model, especially if the use case for the machine learning model is about a prediction. In some applications, however, there are multiple target parameters. One of those applications is to analyze quality related parameters in a production process. For this specific application the target parameters may or may not be correlated, or the correlation between them may not be known. Therefore, a trained model for each individual target parameter with a joined loss function is required. This has been observed in various applications such as traffic analysis, food sciences etc; one of them described in the science article “Machine learning-based multi-target regression to effectively predict turning movements at signalized intersections” from Khaled Shaaban, Ali Hamdi Mohammad, Ghanim Khaled and Bashir Shaban (18th Jan. 2021, available online on ScienceDirect.com since 16th Mar. 2022). The most common approach in these scenarios is to burn down multiple target parameters to one joint parameter via pre-processing, or to just use one single-output model for every target parameter.

### BRIEF SUMMARY OF THE INVENTION

The task of this patent application is therefore to provide a more efficient way to analyze different target parameters of a production process via a machine learning model.

This task has been solved by a method for improving a production process of a product via a computer wherein the computer runs a software performing a machine learning model which is used to predict target production process parameters based on specific input data of the production process and therefore trained with a specific training dataset regarding that input data and target parameters, and finally the predicted target parameters are used to improve the production process, wherein
the machine learning model predicts at least two different target parameters at the same time and is therefore trained with a joint training data set adapted to the at least two target parameters. This invention allows for modeling of two targets using a single-output regression model. The same architecture as a single output regression model can be used to generate predictions for both targets. The correlation between the targets, if any, can also be used to improve performance of the model. By concatenating the datasets of both target variables the overall dataset size increases which increases the learning potential of the trained model. Furthermore, given that now one model is trained for multiple target variables with a single output the model is capable of understanding holistic relationships that exist for both targets.

Advantageous and therefore preferred further developments of this invention emerge from the associated subclaims and from the description and the associated drawings.

One of those preferred further developments of the disclosed method comprise that the at least two target parameters are chosen are correlated to and/or dependent on each other to improve the performance of the model. The usage of one model for multiple target parameters works the best, if those multiple parameters correlate or are dependent on each other in any way, because then the model can determine and use the patterns which provide the basis for the correlation/dependency which greatly enhances the performance of the model-based prediction. The more independent the multiple parameters are from each other, the less beneficial is the application of the one-model-multiple-target approach.

Another one of those preferred further developments of the disclosed method comprise that the at least two correlated target parameters result from the same production process. If they do a correlation is almost sure for most cases, since different parameters of the same process usually either affect each other at least in some way or are even dependent on each other.

Another one of those preferred further developments of the disclosed method comprise that the production process is a chemical mechanical polishing or planarization process (CMP). While in general the one-model approach is applicable to every production process and beyond to actually every use case where a least two, preferably correlated/dependent, parameters shall be predicted, for a CMP it is highly applicable since this process comprise of a lot of correlated/dependent parameters which can be predicted by the trained model.

Another one of those preferred further developments of the disclosed method comprise that the at least two target parameters are the defectivity and removal rate which result from performing a CMP process step. Both parameters are usually measured during the CMP process step and are slightly correlated which makes the application of the one-model-multiple-target approach very suitable. As said before, the invention is not limited to these two parameters of an CMP process.

Another one of those preferred further developments of the disclosed method comprise that the prediction of removal rate and defectivity are used to assess the quality of the product before it is shipped out to the customer to improve the production process by starting suitable corrective actions and root cause investigations. The removal rate and defectivity can only be measured during the production process itself, so in this case the prediction of the model for the two target parameters will be used to improve the production process on-the-fly before performing this step.

Another one of those preferred further developments of the disclosed method comprise that the training data set is structured in form of a table and at least one additional data column is added to the table with information on which target parameter the model will be trained with every specific row of the training data set. This/these additional data column(s) contain for every row of the training data set the information for which target parameter the respective training data in the respective row shall be applied. Multiple options are possible here. From a mere Boolean value where every column is assigned to one target and indicates if this target shall be used, e.g. in form of binary values used as a bit or decision mask, over numeric value(s) with specific assigned meanings, like integer values, up until full string values for more difficult cases and beyond, everything is possible. Which option is used depends on the specific case and its specific requirements like parsing/processment speed and so on.

Another one of those preferred further developments of the disclosed method comprise that a Ridge regression is used to train the model. This enables a very efficient way to train the model but is only one possible option, though.

Another approach to solve the given task comprise of a system for improving a production process of a product comprising of a computer, a software with a machine learning model performed on the computer, at least one production device and a data network connecting all system components, wherein the system is configured to predict at least two different target parameters at the same time based on specific input data of the production process from the at least one production device with the model being trained with a joint training data set adapted to the at least two target parameters and the input data, and wherein finally the at least one production device is configured with the predicted target parameters therefore improving the production process. The respective specific kinds of computer, production devices and networks depend on the individual use case. As computer a standard personal computer also in form of a standard notebook can be used, but also every other kind of computer which has suitable computing capacity, memory et al enabling it to run the software with the model. The production device(s) could include devices used for the CMP process and as network everything from a simple Ethernet based LAN, Wifi, or Bus system can be used which is able to connect the involved system components.

### DETAILED DESCRIPTION OF THE INVENTION

The method and system according to the invention and functionally advantageous developments of those are described in more detail below with reference to the associated drawings using at least one preferred exemplary embodiment. In the drawings, elements that correspond to one another are provided with the same reference numerals.

The drawings show:

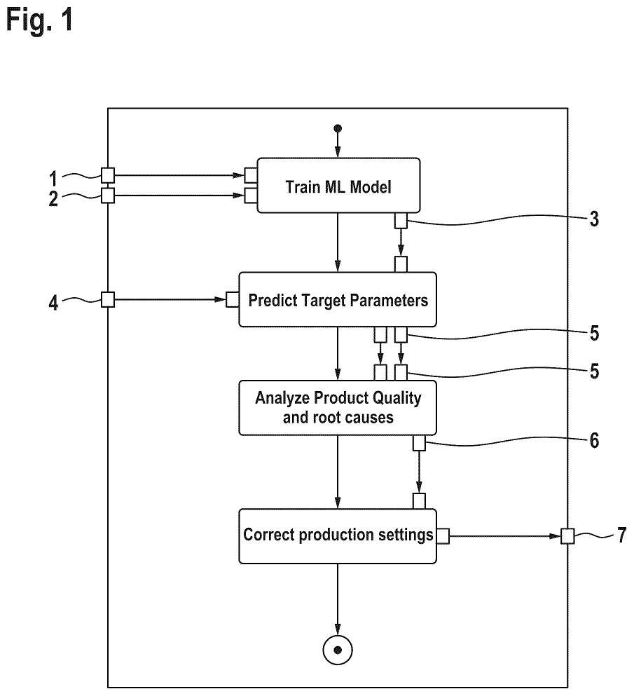

FIG. 1: A schematic view on the invented method

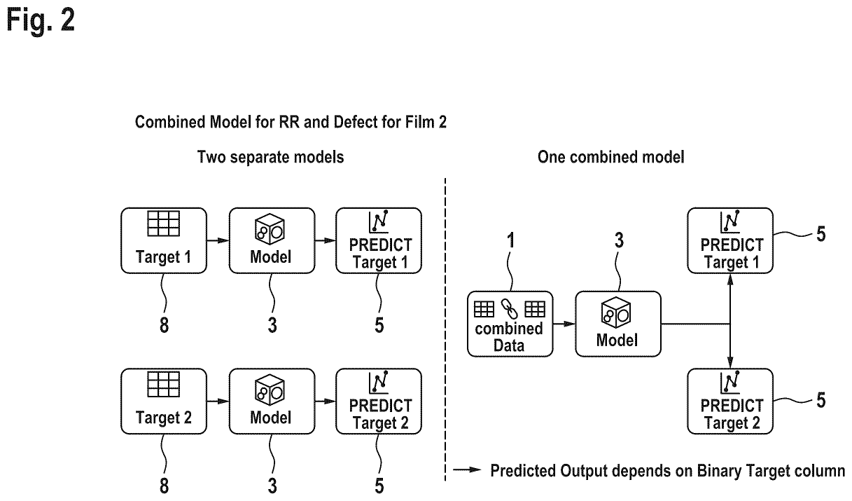

FIG. 2: Each the classic and the inventive approach for a model based prediction of removal rate and defectivity

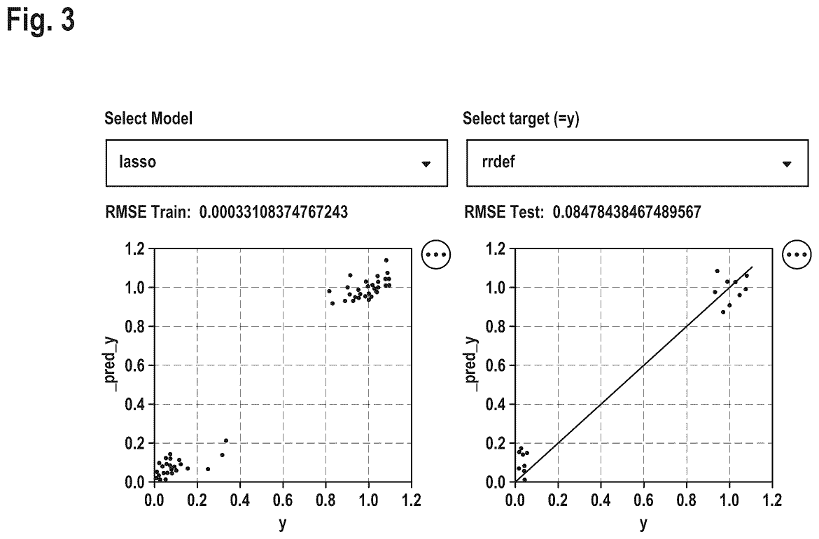

FIG. 3: The combined modeling approach to predict removal rate and defect

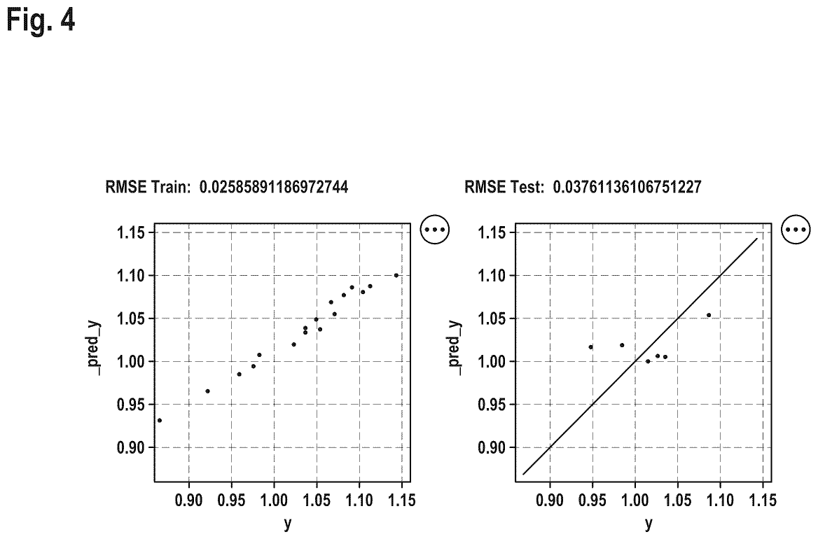

FIG. 4: The removal Rate model using single output machine learning algorithm. Left: Training set, Right: Test set

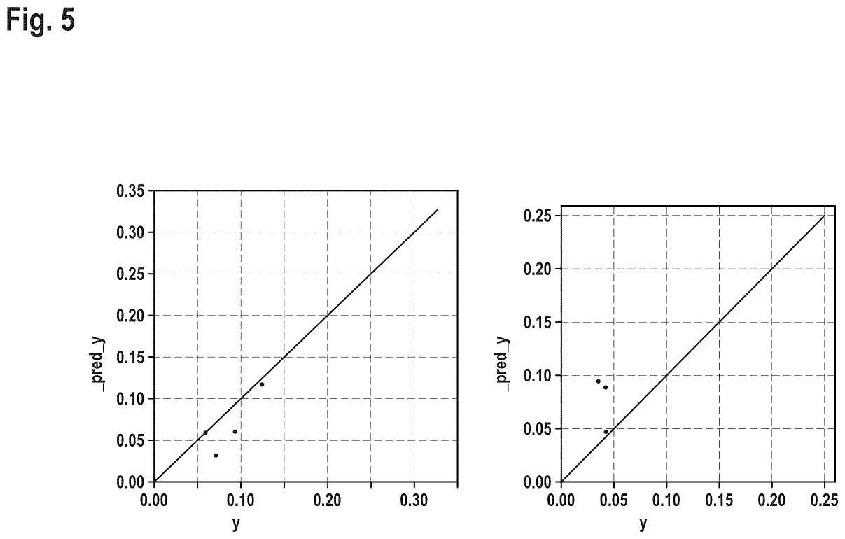

FIG. 5: The defect model using single output machine learning algorithm. Left: Training set, right: Test set

A preferred embodiment of the presented invention is to use the one-model-multiple-target approach for chemical mechanical polishing (CMP) or planarization process. This is a part of a wafer production process to smooth the wafer surfaces with the combination of chemical and mechanical forces. It can be thought of as a hybrid of chemical etching and free abrasive polishing. The performance of the used CMP slurry comes down to a combination of factors, but they can be generally correlated close to the choice of micro-abrasive. Two major performance parameters to determine the performance of slurries are:

Removal Rate: The material removal rate is defined as the amount of material removed from the workpiece per unit time. The material removal rate can be calculated from the volume of material removal or from the weight difference before and after machining. It is an indication of how fast or slow a film is being polished away. In context with the CMP slurry the removal rate refers to the rate at which the CMP slurry removes surface material from a substrate. Smaller grains usually mean lower removal rates.

Defectivity: Explains the extent to which the CMP slurry will impart surface defects such as micro-scratches. Larger PSDs typically translate to higher defectivity.

In the following an example in form of a preferred embodiment will be shown. Here the slurry manufacturing process parameters are used to predict the removal rate and defects. FIG. 1 shows the necessary method steps. To train and apply the used model a standard notebook with a 2.4 GHz quad-core and 16 GB working memory has been used. The model was a ridge regression model implemented with a Python script as a single-output/multiple-target model. Originally this task was done by individually modeling defects and removal rate with two different trained models. However, when applying the invented approach, the described single output/multiple target model is used for the two target parameters, as can be seen in a schematic overview in FIG. 2 which shows on the left side the old approach and on the right side the new invented approach. In this case both, the removal rate and defectivity, are slightly correlated, which the model picks up as well, thereby improving the performance. In the following figures the results of the one-model-two-target approach is shown.

FIG. 3 shows the result of the one-model-two-target approach to predict removal rate and defect. Data-points near “0” model the removal rate and data point near “1” model the defectivity. The left side of the figure shows the training set results and the right diagram the real test set results.

For comparing reasons also the original approach with two models is shown. Here two different single output regression models are made to predict removal rate and defects. The targets were treated individually and uncorrelated.

FIG. 4 shows therefore the Removal Rate model using single output machine learning algorithm. Left side shows the results of the training set and the right side the result of the real test set.

FIG. 5 shows the respective Defectivity model using a single output machine learning algorithm. Left side shows the results of the training set, right side shows the results of the real test set.

So in summary it can be seen that the disclosed inventions allows for both target parameters a potential increase for the model accuracy as well as it enables to gain a better understanding of the overarching relationship between the target variables and the input variables.

### LIST OF REFERENCES

1 Joint Data Set
2 Computer
3 Trained Model
4 Process Input Data
5 Target Parameters
6 Root Causes
7 Corrected Process Parameters

1. A method for improving a production process of a product via a computer wherein the computer runs a software performing a machine learning model which is used to predict target production process parameters based on specific input data of the production process and therefore trained with a specific training dataset regarding that input data and target parameters, and finally the predicted target parameters are used to improve the production process, wherein the machine learning model predicts at least two different target parameters at the same time and is therefore trained with a joint training data set adapted to the at least two target parameters.

2. A Method according to claim 1, wherein the at least two target parameters are chosen which are correlated to and/or dependent on each other to improve the performance of the model.

3. A Method according to claim 2, wherein the at least two correlated target parameters result from the same production process.

4. A Method according to claim 1, wherein the production process is a chemical mechanical polishing or planarization process (CMP).

5. A Method according to claim 4, wherein the at least two target parameters are the defectivity and removal rate which result from performing a CMP process step.

6. A Method according to claim 5, wherein the prediction of removal rate and defectivity are used to assess the quality of the product before it is shipped out to the customer to improve the production process by starting suitable corrective actions and root cause investigations.

7. A Method according to claim 1, wherein the training data set is structured in form of a table and at least one additional data column is added to the table with information on which target parameter the model will be trained with every specific row of the training data set.

8. A Method according to claim 1, wherein a Ridge regression is used to train the model.

9. A System for improving a production process of a product comprising of a computer, a software with a machine learning model performed on the computer, at least one production device and a data network connecting all system components, wherein the system is configured to predict at least two different target parameters at the same time based on specific input data of the production process from the at least one production device with the model being trained with a joint training data set adapted to the at least two target parameters and the input data, and wherein finally the at least one production device is configured with the predicted target parameters therefore improving the production process.
